(19) United States
(12) Patent Application Publication
(10) Pub. No.: US 2024/0354155 A1
(43) Pub. Date: Oct. 24, 2024

(54) TASK SCHEDULING METHOD AND AI CLOUD COMPUTING SYSTEM

(71) Applicant: MONTAGE TECHNOLOGY CO., LTD., Shanghai (CN)

(72) Inventors: Xingbo XU, Shanghai (CN); Jingzhong YANG, Shanghai (CN); Gang SHAN, Shanghai (CN); Zhiwei HOU, Shanghai (CN); Tianning WANG, Shanghai (CN); Xiao HAN, Shanghai (CN)

(73) Assignee: MONTAGE TECHNOLOGY CO., LTD., Shanghai (CN)

(21) Appl. No.: 18/643,580

(22) Filed: Apr. 23, 2024

(30) Foreign Application Priority Data
Apr. 23, 2023 (CN) 202310445180.3

(51) Int. Cl. G06F 9/48

(52) U.S. Cl. CPC G06F 9/4881

(57) ABSTRACT

A task scheduling method and an AI cloud computing system are provided. The task scheduling method comprises: decomposing, via a processor, a computing task into multiple sequent subtasks, and obtaining multiple candidate paths that are capable of processing the sequent subtasks based on a network topology information table, wherein the candidate paths include one or more computing nodes selected from multiple computing nodes, and the computing nodes are configured to process subtasks that match their supported operation types; obtaining feature vectors including feature information of each candidate path and feature information of each subtask, and calculating a total required time for each candidate path to complete the multiple sequent subtasks based on the feature vectors; and selecting the candidate path with the shortest total time to process the multiple sequent subtasks.

### CROSS-REFERENCE TO PRIOR APPLICATION

This application claims priority to Chinese Application No. 202310445180.3 filed on Apr. 23, 2023, which is incorporated herein by reference in its entirety.

### TECHNICAL FIELD

This application relates to the field of artificial intelligence computation technology, and discloses a task scheduling method and an AI cloud computing system.

### BACKGROUND

When a computing task is decomposed into multiple corresponding subtasks, it is necessary to determine sequence of processing subtasks according to the constraint relationship of subtasks, and assign different subtasks to appropriate computing nodes based on the features of the subtasks and the distribution of computational resources, so as to shorten the overall computing time of the task and/or improve throughput.

Traditional task scheduling algorithms have relatively fixed parameter selection in the calculation of factors that affect completion time, and most of them rely on certain prior knowledge, and there are certain assumptions and neglects in the calculation of parameters, so these algorithms will have certain restrictions in use, and have less flexibility and applicability. When the environment changes, for example, the complexity of the task increases, they may lead to an increase in the complexity of scheduling, and the time complexity may increase accordingly. The computational accuracy of traditional task scheduling algorithms may be affected.

This section aims to provide background or context for the implementation of the application stated in the claims. The description here should not be considered prior art merely because it is included in this section.

### SUMMARY OF THE INVENTION

An object of the present application is to provide a task scheduling method, which aims at the shortest task completion time under the premise of satisfying task constraints, and extracts feature information that affects the task completion time from multiple dimensions as a parameter to calculate a required time for each path, so as to obtain a path with the shortest required time.

In one aspect, the present application provides a task scheduling method, comprising:
decomposing, via a processor, a computing task into multiple sequent subtasks, and obtaining multiple candidate paths that are capable of processing the sequent subtasks based on a network topology information table, wherein the candidate paths include one or more computing nodes selected from multiple computing nodes, and the computing nodes are configured to process subtasks that match their supported operation types;
obtaining feature vectors including feature information of each candidate path and feature information of each subtask, and calculating a total required time for each candidate path to complete the multiple sequent subtasks based on the feature vectors; and
selecting the candidate path with the shortest total time to process the multiple sequent subtasks.

In some embodiments, calculating the total required time for each candidate path to complete the multiple sequent subtasks further comprises: calculating the total required time for each candidate path to complete the multiple sequent subtasks via a regression model.

In some embodiments, the multiple computing nodes are connected to the processor, and the computing nodes are connected to each other, wherein the computing nodes are configured to support one or more operation types;
wherein, the network topology information table comprises: an IP address of a host where the processor is located, an index of each computing node, operation types supported by each computing node, a load rate, number of adjacent computing nodes of each computing node, and operation types supported by the adjacent computing nodes.

In some embodiments, the network topology information table is updated in real-time to dynamically modify the candidate paths.

In some embodiments, the feature information of the candidate paths comprises information of each computing node that forms the candidate paths, and network topology information.

In some embodiments, the information of the computing node comprises: supported operation types, current load rate, usage, and number of concurrent tasks.

In some embodiments, the network topology information comprises: distance between adjacent computing nodes in the same candidate path.

In some embodiments, the feature information of the subtasks comprises: batch size, data packet size of the subtasks, and data type.

In some embodiments, the feature vectors further comprises feature information of hardware.

In some embodiments, the feature information of the hardware comprises: number of processor cores, processor load, memory size, and memory usage.

In another aspect, the present application also provides an AI cloud computing system, comprising: a plurality of AI computing platforms, each AI computing platform comprising at least one computing component, each computing component comprising: a processor and multiple computing nodes, wherein the computing nodes are connected to the processor, and the computing nodes are connected to each other; wherein the processor is configured to:
decompose a computing task into multiple sequent subtasks, and obtain multiple candidate paths that are capable of processing the sequent subtasks based on a network topology information table, wherein the candidate paths include one or more computing nodes selected from multiple computing nodes, and the computing nodes are configured to process subtasks that match their supported operation types;
obtain feature vectors including feature information of each candidate path and feature information of each subtask, and calculating a total required time for each candidate path to complete the multiple sequent subtasks based on the feature vectors, and select the candidate path with the shortest total time to process the multiple sequent subtasks.

A large number of technical features are described in the specification of the present application, and are distributed in various technical solutions. If a combination (i.e., a technical solution) of all possible technical features of the present application is listed, the description may be made too long. In order to avoid this problem, the various technical features disclosed in the above summary of the present application, the technical features disclosed in the various embodiments and examples below, and the various technical features disclosed in the drawings can be freely combined with each other to constitute various new technical solutions (all of which are considered to have been described in this specification), unless a combination of such technical features is not technically feasible. For example, feature A+B+C is disclosed in one example, and feature A+B+D+E is disclosed in another example, while features C and D are equivalent technical means that perform the same function, and technically only choose one, not to adopt at the same time. Feature E can be combined with feature C technically. Then, the A+B+C+D scheme should not be regarded as already recorded because of the technical infeasibility, and A+B+C+E scheme should be considered as already documented.

### BRIEF DESCRIPTION OF THE FIGURES

FIG. 1 is a flowchart of a task scheduling method according to an embodiment of the present application.

FIG. 2 is a schematic structural diagram of an AI computing platform and candidate paths according to an embodiment of the present application.

FIG. 3 is a schematic diagram of a training/inference procedure for a regression model neural network according to an embodiment of the present application.

FIG. 4 is a schematic diagram of model iteration according to an embodiment of the present application.

### DETAILED DESCRIPTION

In the following description, numerous technical details are set forth in order to provide the readers with a better understanding of the present application. However, those skilled in the art can understand that the technical solutions claimed in the present application can be implemented without these technical details and various changes and modifications based on the following embodiments.

In order to make the objects, technical solutions and advantages of the present application clear, embodiments of the present application will be further described in detail below with reference to the accompanying drawings.

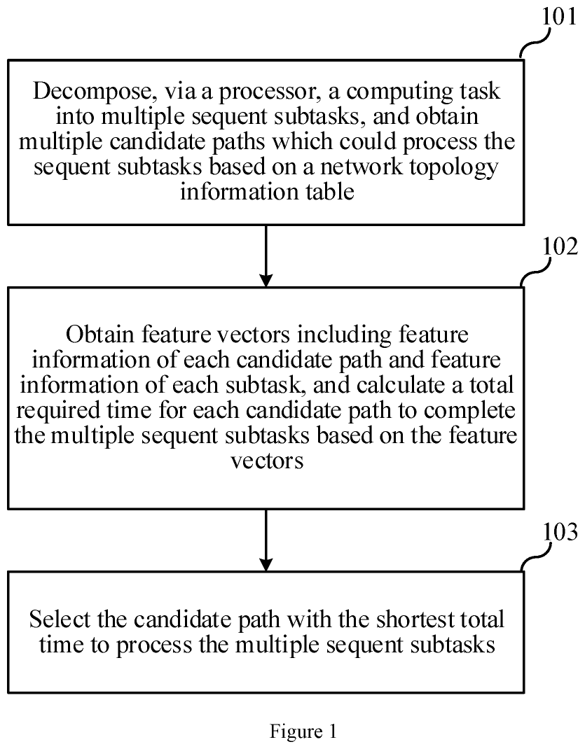

A first embodiment of the present application relates to a task scheduling method, the flowchart of which is shown in FIG. 1, the method includes the following steps:

Step 101, decomposing, via the processor, a computing task into multiple sequent subtasks, and obtaining multiple candidate paths that are capable of processing the multiple sequent subtasks based on a network topology information table. Wherein the candidate paths include one or more computing nodes selected from multiple computing nodes, and the computing nodes are configured to process subtasks that match their supported operation types (OP).

The task scheduling method in this embodiment may be applied to an AI computing platform, each AI computing platform includes at least one computing component, and each computing component includes a processor and multiple computing nodes. Wherein the multiple computing nodes are connected to the processor, and the multiple computing nodes are connected to each other. The processor and the computing nodes, and the computing nodes may be connected to each other, for example, via a PCIe interface, but the present application is not limited to this and may be connected by any suitable means. Wherein the processor is used to decompose a computing task into multiple sequent subtasks and obtain multiple candidate paths that are capable of processing the multiple sequent subtasks based on a network topology information table. Each candidate path includes one or more computing nodes. The computing node is configured to support one or more operation types. In some embodiments, the computing node may be a Near-Memory Computing Module (NCM), but not limited to this, in other embodiments, the computing node may also be a computing module such as GPGPU and FPGA, which is suitable for more complex computing applications such as machine training.

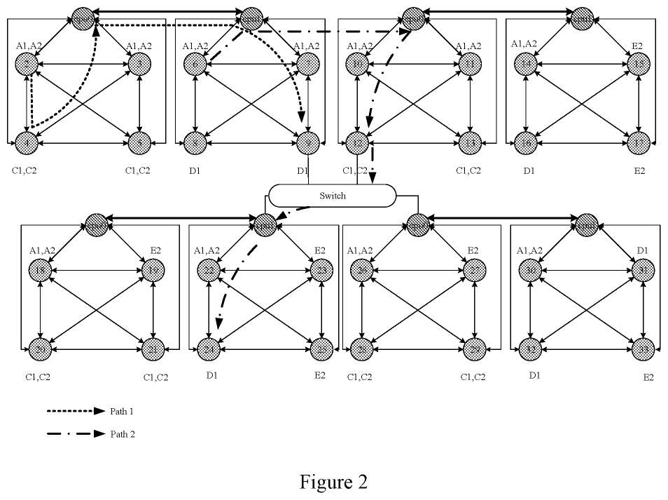

The structure of the AI computing platform is shown in FIG. 2, which includes a plurality of computing components. The following takes each computing component including one processor and four computing nodes as an example for explanation. In each computing component, the four computing nodes are connected to the processor, and the four computing nodes are connected to each other. A computing node in one computing component may be connected to a processor in another computing component, for example, via a switch. In FIG. 2, the computing node 2 may be configured to implement two logical operations: A1 and A2, the computing node 4 may be configured to implement two logical operations: C1 and C2, and so on. It should be understood that the operation types implemented by each computing node can be set according to actual needs, which are not limited in this embodiment.

In one embodiment, the processor may obtain multiple candidate paths based on the network topology information table. Wherein, the network topology information table includes: an IP address of a host where the processor is located, an index of the computing node, operation types supported by the computing node, a load rate, number of adjacent computing nodes, and operation types supported by the adjacent computing nodes.

As shown in FIG. 2, the computing task is decomposed into three subtasks, which are, in order, A1, C2, and D1 respectively (also represented as A1->C2->D1 in the following text). The processor can obtain multiple paths which can process the subtasks A1->C2->D1 based on the network topology information table. FIG. 2 shows two paths, Path 1 and Path 2. The Path 1 goes from computing node 2 to computing node 4, and goes through CPU0 and CPU1, then to computing node 9. The Path 2 starts from computing node 6, passes through CPU0 and CPU1 to computing node 12, and then passes through the switch to computing node 24. It should be understood that the computing platform needs to select a path that takes the shortest time to perform the corresponding subtasks from the multiple candidate paths.

In one embodiment, the network topology information table is updated in real-time to dynamically modify the candidate paths.

Step 102, obtaining feature vectors including feature information of each candidate path and feature information of each subtask, and calculating a total required time for each candidate path to complete the multiple sequent subtasks based on the feature vectors.

The present embodiment extracts feature vectors from multiple dimensions that affect the task completion time. In some embodiments, these feature vectors mainly include feature information of each candidate path and feature information of each subtask.

The feature information of each candidate path includes information of each computing node that makes up the candidate path, and network topology information. Specifically, the information of a computing node mainly includes operation types (OP) supported by the computing node, current load rate, usage, and number of Concurrent tasks. Wherein the different operation types supported by the computing nodes result in different computational complexity and amount, and the required time also varies accordingly. Similarly, for each computing node, its current load situation, usage, and number of Concurrent tasks will directly affect the task completion time. The network topology information mainly refers to a distance between the adjacent computing nodes in the same path. The distance between the adjacent computing nodes can affect the copying, transmission distance, and transmission time of data packets.

The feature information of the subtasks includes: batch size, data packet size of the subtasks, and data type.

In some embodiments, the feature vectors that affect task completion time further includes feature information of hardware. The hardware information mainly includes the number of processor cores (CPU num), processor load (CPU load), Memory size, and Memory usage.

After extracting the feature vectors that affect the task completion time, the total required time for the candidate path can be calculated based on these feature vectors. The present embodiment can calculate the total required time for each candidate path by means of a regression model, as may be described below.

Step 103, selecting a candidate path with the shortest total time to process the multiple sequent subtasks.

The application aims at the shortest task completion time under the premise of satisfying task constraints, and extracts feature information that affects the task completion time from multiple dimensions (including feature information of the computing nodes, feature information of the subtasks, the network topology information, and the hardware information etc.) as a parameter to calculate the required time for each path, so as to obtain a path with the shortest required time.

The following will describe in detail how an embodiment of the present application to calculate a required time for each candidate path by means of a regression model.

The embodiment of the present application constructs a regression model. By inputting feature vectors affecting the task completion time into this regression mode, predicted values of task processing time for each candidate path can be obtained, so that the path with the shortest required time can be selected out.

Specifically, after obtaining multiple candidate paths, the feature vectors that affect task completion time can be extracted based on each candidate path. As mentioned above, these feature vectors include the information of the computing nodes, the network topology information, the feature information of the subtasks, and the hardware information, as shown in Table 1.

TABLE 1
feature vectors

| | | | | | Number | | | | | | Number |
|---|---|---|---|---|---|---|---|---|---|---|---|
| | | Load | Node | Node | of | | | Load | Node | Node | of |
| | Node | rate | usage | distance | concurrent | | Node | rate | usage | distance | concurrent |
| Path | 1 | 1 | 1 | 1 | tasks 1 | | 3 | 3 | 3 | 3 | tasks 3 |
| 1 | A1 | 30.2 | 65 | 1 | 4 | . . . | D1 | 45.3 | 76 | 1 | 2 |
| 2 | A1 | 36.5 | 70 | 1 | 4 | . . . | D1 | 14.6 | 52 | 1 | 2 |
| 3 | A1 | 66.8 | 90 | 1 | 2 | . . . | D1 | 24.6 | 62 | 3 | 4 |
| . . . | . . . | . . . | . . . | . . . | | . . . | . . . | . . . | . . . | . . . | |
| n | A1 | 86.6 | 99 | 2 | 6 | . . . | D1 | 56.3 | 50 | 1 | 4 |

| | | | | Number | | | |
|---|---|---|---|---|---|---|---|
| | | Data | | of | | | |
| | Batch | Packet | Data | processor | Processor | Memory | Memory |
| Path | size | size | type | cores | load | size | usage |
| 1 | 32 | 100 | 1 | 20 | 96 | 512 | 8.3 |
| 2 | 32 | 100 | 1 | 20 | 90 | 512 | 8.1 |
| 3 | 32 | 100 | 1 | 20 | 85 | 512 | 9.6 |
| . . . | | | | | | | |
| n | 32 | 100 | 1 | 20 | 96 | 512 | 9.5 |

Then, the feature vectors in the above table of feature vectors are converted into a feature matrix;

$$[ \begin{matrix}A 130.26514 … D 145.3761232100120965128 \text{.3} \\ A 136.57014 … D 114.6521232100120905128 \text{.1} \\ A 166.89012 … D 124.6623432100120855129 \text{.6} \\ … \\ A 186.69926 … D 156.3501432100120965129 \text{.5}\end{matrix} ]$$

In this feature matrix, each row vector is an input data of one candidate path, and the feature matrix is input into the regression model, through which the predicted values of task processing time t1 to tn for the multiple candidate paths can be calculated and output. Finally, the predicted values t1 to tn are post-processed to select the shortest time predicted value t_min, and the path corresponding to this t_min is a task path with the shortest running time.

In this case, the regression model neural network structure may consist of 1 input layer, 2 hidden layers, and 1 output layer, where the hidden layers are all composed of 64 neurons and the activation function is Rectified Linear Unit (ReLU) function. For a single neuron in it, the output output is:

output=σ(net)=max(0,net)

$$net = {\sum }_{i = 0}^{n} {w}_{i} {x}_{i}$$

Wherein x0, x1 . . . xn are the input data corresponding to one candidate path, and w0, w1 . . . wn are the weights corresponding to the input data x0, x1 . . . xn respectively.

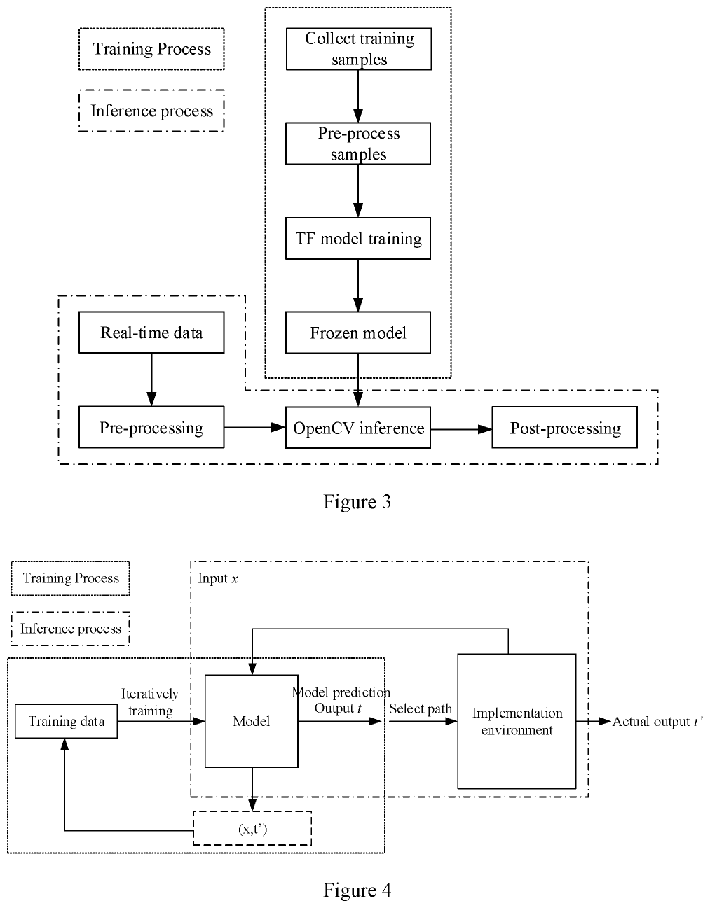

Table 2 shows the structural parameter information in the network model, based on which the training/inference procedure is shown in FIG. 3. In practice, the model can be constructed on Tensorflow, Pytorch or Keras based on parameter information.

TABLE 2
Network model structure parameter information

| Type | Shape | Input size |
|---|---|---|
| Fully connected | 64 | (None, 22) |
| ReLU | — | — |
| Fully connected | 64 | (None, 64) |
| ReLU | — | — |
| Fully connected | 1 | (None, 64) |

Wherein, the feature data obtained in data collecting step is mainly stored in the network topology information table and SC4NCM protocol data packet. SC4NCM is a near memory based segmented computing protocol, which is a communication protocol within an AI computing platform based on NCM (Near-Memory Computing Module). The information in the computing network will be updated in real-time to the network topology information table, and information related to the data packet, such as batch, can be directly read from corresponding fields in the data packet. Although there may consume a certain amount of time, the time consumed is relatively small compared to the overall scheduling time. The maintenance and reading/writing of data in the network topology information table and SC4NCM are not complicated.

The pre-processing steps in FIG. 3 refer to collecting corresponding data based on the selected features, performing pre-processing operations such as data cleaning and normalization, and then forming corresponding feature vectors as input data for the network model. The pre-processing operation is split from the algorithmic model and is relatively simple and does not add the complexity of the model itself. Further, the proportion of overall consumed time of the pre-processing operation is also very small.

The post-processing process is to further process the output of the model, that is, to select the smallest predicted time from the predicted time corresponding to each path output by the model:

$$t\_min = min ( t 1 , t 2 , ... , tn )$$

A path corresponding to t_min is the final selected scheduling path.

The above inference procedure can be trained iteratively. During training, it is necessary to separately record the input and actual output of the model. The pre-processing steps of the collected data are the same as those in the training process mentioned above. The process of iteration is shown in FIG. 4. The input x (feature data) and the actual output t′ obtained in the specific implementation environment form a new dataset, which can be trained again on the basis of the original model to realize the model iteration, enabling the model to better adapt to the specific environment and improve prediction accuracy.

A second embodiment of the present application relates to an AI cloud computing system, the cloud computing system includes: a plurality of AI computing platforms, each AI computing platform includes at least one computing component, and each computing component includes a processor and multiple computing nodes, wherein the computing nodes are connected to the processor, and the computing nodes are connected to each other. Wherein, via the processor, a computing task is decomposed into multiple sequent subtasks, and multiple candidate paths capable of processing the sequent subtasks are obtained based on a network topology information table. Wherein the candidate paths include one or more computing nodes selected from multiple computing nodes, and the computing nodes are configured to process subtasks that match their supported operation types. By the processor, feature vectors including feature information of each candidate path and feature information of each subtask are obtained, a total required time for each candidate path to complete the multiple sequent subtasks based on the feature vectors is calculated, and the candidate path with shortest total time to process the multiple sequent subtasks is selected.

The first embodiment is a method embodiment corresponding to the present embodiment, and the technical details in the first embodiment can be applied to the present embodiment, and the technical details in the present embodiment can also be applied to the first embodiment.

The embodiments of the application aims at the shortest task completion time under the premise of satisfying task constraints, and extracts feature information that affects the task completion time from multiple dimensions (including feature information for each candidate path and feature information for each subtask, etc.) as a parameter to calculate the required time for each path, so as to obtain the path with the shortest required time. This method is more tailored to the specific execution environment, which is beneficial for improving the computational accuracy.

Furthermore, this application calculates the total required time for each candidate path to complete the subtasks via a regression model based on machine learning, which can reduce the dependence on prior knowledge. Moreover, feature factors that affect the task completion time from multiple dimensions are extracted to train the regression model, which can autonomously learn parameters based on specific execution environment and tasks, increasing the accuracy of the model and being more robust. The accuracy of the model is not affected when the number of nodes in the network and the number of processing tasks change, thus making it suitable for multi-service scenarios and cloud service scenarios with good applicability and scalability. In addition, the model is simple, easy to solve, and easy to deploy.

It should be noted that those skilled in the art should understand that the implementation functions of the modules shown in the embodiments of the above AI cloud computing system can be referred to the relevant description of the foregoing task scheduling method. The functions of each module shown in the above embodiments of the AI cloud computing system can be implemented by a program (executable instructions) running on the processor, or by a specific logic circuit. If the AI cloud computing system described above is implemented in the form of a software function module and sold or used as an independent product, it may also be stored in a computer-readable storage medium. Based on this understanding, the technical solutions of the embodiments of the present application can be embodied in the form of software products in essence or part of contributions to the prior art. The computer software product is stored in a storage medium, and includes multiple instructions to enable a computer device (which may be a personal computer, server, or network device, etc.) to perform all or part of the methods described in the embodiments of the present application. The foregoing storage media include various media that can store program codes, such as a U disk, a mobile hard disk, a read-only memory (ROM), a magnetic disk, or an optical disk. In this way, the embodiments of the present application are not limited to any specific combination of hardware and software.

Correspondingly, the embodiments of the present application also provide a computer-readable storage medium in which computer-executable instructions are stored. When the computer-executable instructions are executed by a processor, the method embodiments of the present application are implemented. The computer-readable storage media includes permanent and non-permanent, removable and non-removable media and can be used by any method or technology to implement information storage. Information can be computer-readable instructions, data structures, program modules, or other data. Examples of computer-readable storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only optical disc read-only memory (CD-ROM), digital multifunctional optical disc (DVD) or other optical storage, magnetic cartridge tapes, magnetic tape disk storage or other magnetic storage devices, or any other non-transport media that can be used to store information that can be accessed by computing devices. As defined herein, a computer-readable storage medium does not include transient computer-readable media (transitory media), such as modulated data signals and carriers.

In addition, an embodiment of the present application also provides an AI cloud computing system, which comprising a memory for storing computer-executable instructions, and a processor; the processor is used to execute the computer-executable instructions stored in the memory to implement the steps in the above method embodiments. Wherein, the processor may be a Central Processing Unit (referred to as “CPU”), or other general-purpose processors, Digital Signal Processor (referred to as “DSP”), Application Specific Integrated Circuit (referred to as “ASIC”) and so on. The aforementioned memory can be read-only memory (ROM), random access memory (RAM), flash memory (Flash), hard disk or solid-state drive, etc. The steps of the method disclosed in various embodiments of the present application may be directly embodied as being performed by a hardware processor, or performed with a combination of hardware and software modules in the processor.

It should be noted that in this specification of the application, relational terms such as the first and second, and so on are only configured to distinguish one entity or operation from another entity or operation, and do not necessarily require or imply any such actual relationship or order between these entities or operations. Furthermore, the term “comprises” or “comprising” or “includes” or any other variations thereof is intended to encompass a non-exclusive inclusion, such that a process, method, article, or device that comprises a multiple elements includes not only those elements but also other elements, or elements that are inherent to such a process, method, item, or device. Without more restrictions, the element defined by the phrase “comprise(s) a/an” does not exclude that there are other identical elements in the process, method, item or device that includes the element. In this specification of the application, if it is mentioned that an action is performed according to an element, it means the meaning of performing the action at least according to the element, and includes two cases: the action is performed only on the basis of the element, and the action is performed based on the element and other elements. Multiple, repeatedly, various, etc., expressions include 2, twice, 2 types, and 2 or more, twice or more, and 2 types or more types.

All documents mentioned in this specification are considered to be included in the disclosure of this application as a whole, so that they can be used as a basis for modification when necessary. In addition, it should be understood that the above descriptions are only preferred embodiments of this specification, and are not intended to limit the protection scope of this specification. Any modification, equivalent replacement, improvement, etc. made within the spirit and principle of one or more embodiments of this specification should be included in the protection scope of one or more embodiments of this specification.

In some cases, the actions or steps described in the claims can be performed in a different order than in the embodiments and still achieve desired results. In addition, the processes depicted in the drawings do not necessarily require the specific order or sequent order shown in order to achieve the desired results. In some embodiments, multitasking and parallel processing are also possible or may be advantageous.

What is claimed is:

1. A task scheduling method, comprising:
decomposing, via a processor, a computing task into multiple sequent subtasks, and obtaining multiple candidate paths that are capable of processing the sequent subtasks based on a network topology information table, wherein the candidate paths include one or more computing nodes selected from multiple computing nodes, and the computing nodes are configured to process subtasks that match their supported operation types;
obtaining feature vectors including feature information of each candidate path and feature information of each subtask, and calculating a total required time for each candidate path to complete the multiple sequent subtasks based on the feature vectors; and
selecting the candidate path with the shortest total time to process the multiple sequent subtasks.

2. The task scheduling method according to claim 1, wherein calculating the total required time for each candidate path to complete the multiple sequent subtasks further comprises: calculating the total required time for each candidate path to complete the multiple sequent subtasks via a regression model.

3. The task scheduling method according to claim 1, wherein the multiple computing nodes are connected to the processor, and the computing nodes are connected to each other, wherein the computing nodes are configured to support one or more operation types;
wherein, the network topology information table comprises: an IP address of a host where the processor is located, an index of each computing node, operation types supported by each computing node, a load rate, number of adjacent computing nodes of each computing node, and operation types supported by the adjacent computing nodes.

4. The task scheduling method according to claim 3, wherein the network topology information table is updated in real-time to dynamically modify the candidate paths.

5. The task scheduling method according to claim 1, wherein the feature information of the candidate paths comprises information of each computing node that forms the candidate paths, and network topology information.

6. The task scheduling method according to claim 5, wherein the information of the computing node comprises: supported operation types, current load rate, usage, and number of concurrent tasks.

7. The task scheduling method according to claim 5, wherein the network topology information comprises: distance between adjacent computing nodes in the same candidate path.

8. The task scheduling method according to claim 1, wherein the feature information of the subtasks comprises: batch size, data packet size of the subtasks, and data type.

9. The task scheduling method according to claim 1, wherein the feature vectors further comprises feature information of hardware.

10. The task scheduling method according to claim 9, wherein the feature information of the hardware comprises: number of processor cores, processor load, memory size, and memory usage.

11. An AI cloud computing system, comprising: a plurality of AI computing platforms, each AI computing platform comprising at least one computing component, each computing component comprising: a processor and multiple computing nodes, wherein the computing nodes are connected to the processor, and the computing nodes are connected to each other; wherein the processor is configured to:
decompose a computing task into multiple sequent subtasks, and obtain multiple candidate paths that are capable of processing the sequent subtasks based on a network topology information table, wherein the candidate paths include one or more computing nodes selected from multiple computing nodes, and the computing nodes are configured to process subtasks that match their supported operation types;
obtain feature vectors including feature information of each candidate path and feature information of each subtask, and calculate a total required time for each candidate path to complete the multiple sequent subtasks based on the feature vectors, and select the candidate path that takes the shortest total time to process the multiple sequent subtasks.
